(19) United States
(12) Patent Application Publication
(10) Pub. No.: US 2021/0035093 A1
(43) Pub. Date: Feb. 4, 2021

(54) A DEVICE, SERVER, METHOD AND PROGRAM

(71) Applicant: PCO 2012 LIMITED, London (GB)

(72) Inventor: Duncan John KENNETT, Sudbury (GB)

(21) Appl. No.: 16/968,013

(22) PCT Filed: Feb. 5, 2019
(86) PCT No.: PCT/GB2019/050300

§ 371 Date: Aug. 6, 2020

(30) Foreign Application Priority Data
Feb. 7, 2018 (GB) 1801952.1

(51) Int. Cl. G06Q 20/38; G06Q 20/12; G06Q 20/22; G06Q 50/14; G06Q 10/02

(52) U.S. Cl. CPC G06Q 20/385; G06Q 20/12; G06Q 10/02; G06Q 50/14; G06Q 20/22

(57) ABSTRACT

A device in communication with a server over a network, the device comprising a processor and a network interface for communication over the network, wherein the processor is configured to: generate a request to purchase a trip and to send this request to the server using the network interface; the processor being further configured to receive a Real Time Payment indicator via the network interface and to send the received Real Time Payment indicator to a financial institution.

### BACKGROUND

### Field of the Disclosure

The present disclosure generally relates to a device, server, method and program.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

Over recent years, payment cards have been a less popular payment method for travel agents when arranging trips or journeys. In many instances, this is typically because of Regulatory restrictions. This is inconvenient for a user. Indeed, even where payment cards are allowed to be used, the data flow around the payment network is quite complex. This results in an increased amount of data being passed around the network.

It is an aim of the present disclosure to reduce the amount of data being passed around the network when a trip is being purchased.

### SUMMARY

Embodiments of the disclosure are defined in the claims.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a device 100 according to embodiments of the disclosure;

FIG. 2 is a server 200 according to embodiments of the disclosure;

FIG. 3 is a known arrangement for booking a journey or trip; and

FIG. 4 is an arrangement according to embodiments of the disclosure.

### DESCRIPTION OF THE EMBODIMENTS

Referring now to the drawings, wherein like reference numerals designate identical or corresponding parts throughout the several views.

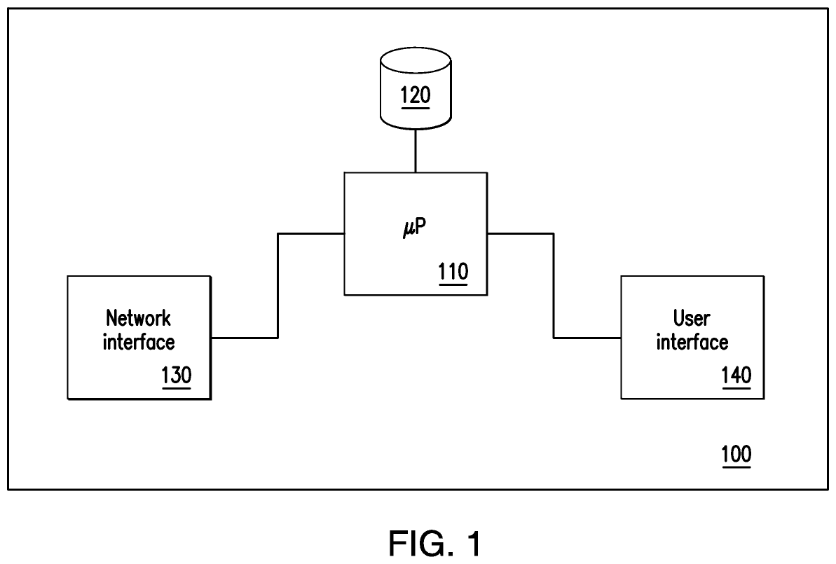

FIG. 1 shows a device according to embodiments of the disclosure. The device 100 may be any kind of device into which a user may input information pertaining to a purchase of a good or service. For example, the device 100 may be a personal (or business) computer, tablet computer, mobile (cellular) telephone, television, cable or satellite set-top box, games console or the like.

In embodiments, the user may input information pertaining to purchase of a travel service such as a flight, hotel, ferry trip or other kind of vehicular transportation. The user may be a professional such as a travel agent or a consumer such as a person at home browsing the Internet for a holiday, for example.

The user will enter the user data by interacting with a user interface 140. The user interface 140 may be a touch-screen, a mouse, keyboard, voice recognition system or the like. The user interface 140 is connected to a processor 110.

The processor 110 is circuitry configured to control the device 100. The processor 110 will operate according to computer readable code which instructs the processor 110 to perform various functions. The computer readable code may be software. The software is stored in information processing apparatus storage 120 which may be solid-state or magnetic or optically readable data storage. The information processing apparatus storage 120 may also contain other user specific information such as profile information defining a user name and password associated with a particular user.

Additionally connected to the processor 110 is a network interface 130. The network interface 130 connects to a network and allows data to be provided over the network. The network interface 130 may communicate with one or more other apparatuses over the network using any appropriate mechanism. For example, the network interface 130 may communicate over a cellular network, or a wired network. The network interface 130 may communicate over a Local Area Network (LAN), a Wide Area Network (WAN), the Internet or over a cellular connection such as 3G, 4G, LTE or the like. Indeed, the network interface 130 may select the appropriate type of connection with the network such as a secure connection for sensitive data or an unsecure connection where the privacy of the data is not important.

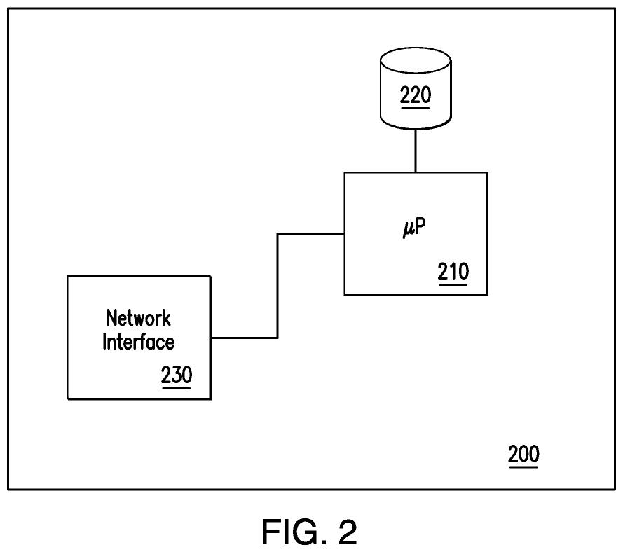

In a typical example, the processor 110 will generate a request and will send this request to another device (such as the server of FIG. 2) over a network using the network interface 130. Similarly, requests or acknowledgements may be received from other devices (such as the server 200 of FIG. 2) using the network interface 130 and these will be sent and processed by the processor 110.

FIG. 2 shows a server 200 according to embodiments of the disclosure. It is envisaged that the server 200 communicates with the device 100 over a network using a server network interface 230. It should be noted that the server 200 may be any kind of device such as a computer, or computing device or may be distributed over several locations or various data centres.

The server 200 is controlled by a server processor 210. The server processor 210 is circuitry configured to control the server 200. The server processor 210 will operate according to computer readable code which instructs the server processor 210 to perform various functions. The computer readable code may be software. The software is stored in server storage 220 which may be solid-state or magnetic or optically readable data storage.

Further connected to the server processor 210 is a server network interface 230. The server network interface 230 connects to a network and allows data to be provided over the network. The server network interface 230 may communicate with one or more apparatuses over the network using any appropriate mechanism. For example, the server network interface 230 may communicate over a cellular network, or a wired network. The server network interface 230 may communicate over a Local Area Network (LAN), a Wide Area Network (WAN), the Internet or over a cellular connection such as 3G, 4G, LTE or the like. Indeed, the server network interface 230 may select the appropriate type of connection with the network such as a secure connection for sensitive data or an unsecure connection where the privacy of the data is not important.

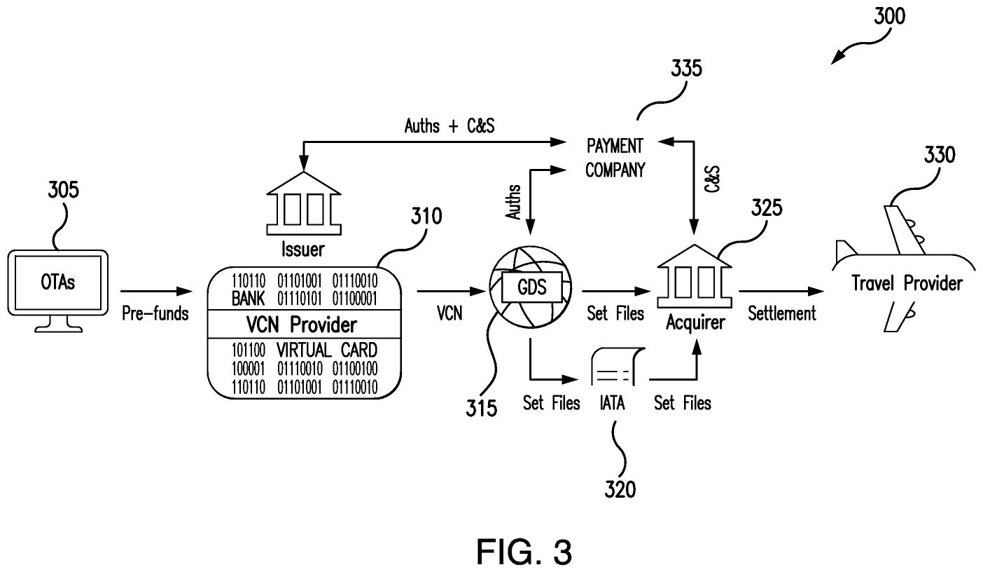

Referring to FIG. 3, a known purchase arrangement 300 is shown. In the specific example, the purchase arrangement pertains to a travel arrangement, although the disclosure is not so limited.

In the purchase arrangement 300, a travel agent 305 wishes to arrange a journey or trip for a client. This trip may include a flight, hotel stay, rental car booking, boat journey or the like. Of course, the travel agent may be a consumer arranging their own journey or trip. The travel agent 305 uses a device 100 as described in FIG. 1 to arrange the trip.

In order to pay for the trip, the travel agent 305 uses a Virtual Credit Card 310. The virtual credit card may be pre-paid or not. The virtual credit card 310 generates a card number specifically for the purchase. So, in other words, in order to pay for the journey or trip, a unique credit card number is generated. The virtual credit card may be generated on a server according to FIG. 2.

The virtual credit card number is sent to a Global Distribution System (GDS) 315. The GDS 315 is a reservation tool used by travel agents and links scheduling platforms for hotels, airlines, car rentals and the like and is deployed on server hardware similar to that described in FIG. 2. Examples of a GDS 315 include Amedeus, Travelport and SABRE. In other words, the GDS 315 is a reservation tool for booking a trip.

As well as sending the virtual credit card information, an authorisation request is sent to a payment company 335. The payment company 335 may be MasterCard 6, Visa 6 or the like. The payment company 335 uses technology that is deployed on server hardware similar to that described in FIG. 2. This authorisation request is to ensure that the payment will be honoured. In other words, the authorisation request is sent to the payment company 335 to ensure that the payment company 335 will honour the payment.

When the payment company 335 agrees to honour the payment, an authorisation is generated by the payment company 335. After the authorisation has been given, the payment company 335 sends the authorisation to the GDS 315 and debits the funds for the trip from the financial institution 325 associated with the virtual credit card number provider. This allows the trip to be arranged. Once the trip has been arranged, a set file describing the itinerary and traveller information is sent to the International Air Transport Association (IATA) 320. This information is sent as a set file of a specified format and containing specific information required to meet transportation regulation. IATA 320 uses technology that is deployed on server hardware similar to that described in FIG. 2.

Further, the set file is sent from the GDS 315 to the financial institution 325 associated with the GDS 315. The financial institution 325 uses technology that is deployed on server hardware similar to that described in FIG. 2. The set files are also sent from IATA 320 to the financial institution 325.

The payment company 335 sends the funds retrieved from the issuer to the financial institution 325 and then the funds are sent from the financial institution 325 to the travel provider 330. The travel provider 330 uses technology that is deployed on server hardware similar to that described in FIG. 2. The journey or trip is then arranged.

It should be noted that the above is based around payment using credit cards or pre-paid credit cards. In the example above, this may be a virtual credit card or the like but it is no way limited to this.

However, this arrangement has a number of challenges based, primarily, on regulatory issues. Firstly, IATA Resolution 890 (which was effective from 1 Jun. 2014) sets conditions for card sales. Moreover, not all airlines accept credit card payments. This means that user convenience is reduced.

Secondly, IATA has set a Transparency in Payments initiative. This enables each airline to clearly define its payment policy based on transparent product information. Again, similar to the first challenge, this means that credit cards are not always accepted. This again reduces user convenience.

Thirdly, there are local regulatory context challenges.

Fourthly, as shown in FIG. 3, even where payment cards are allowed to be used, the data flow around the various parts of the network is quite complex. This means that the network topography is complex and the amount of data passing around the network is high.

It is at least one of these regulatory and technical considerations that embodiments of the disclosure aim to address.

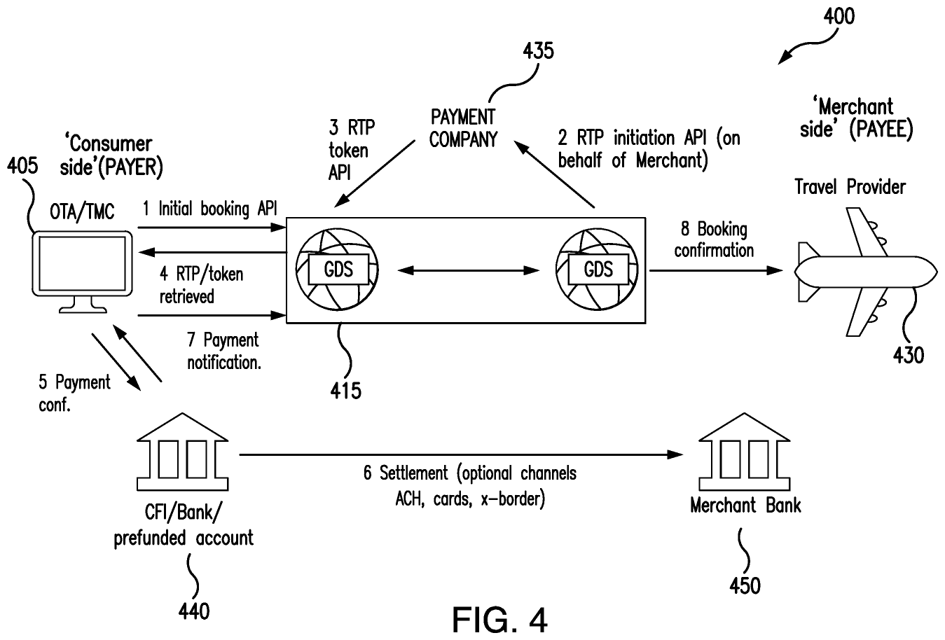

FIG. 4 shows a flow chart 400 describing embodiments of the disclosure. Specifically, in FIG. 4, payment is made directly from one bank account to another bank account. This reduces the amount of data sent around a network and addresses the regulatory issues identified above.

The travel agent (or consumer) 405 interacts with a device 100 to define an itinerary for a trip they wish to make. This is done using Application Software stored within the storage 120. This in embodiments is formed from an Application Programming Interface (API). This is step 1 in FIG. 4.

In particular, the travel agent 405 interacts with a GDS system 415 using the API. Similar to the explanation of FIG. 3, the GDS system 415 will be provided on a server 200 like that described in FIG. 2.

The GDS system 415 sends a Real Time Payment (RTP) request to the payment company 435. This is step 2. The Real Time Payment request is a request to make a Real Time Payment from one bank account to another bank account. The RTP request includes information such as the bank account information, the amount to be transferred, a reference identifying the trip to which the transfer pertains and the like. The RTP request will be made on an API and will be made on behalf of the travel provider. Again, the payment company 435 will use a server 200 similar to that of FIG. 2.

The payment company 435 will use the Real Time Payment request to generate a token. The token, as will be appreciated by once skilled in the Art, is a process by which the sensitive data contained in the Real Time Payment Request (such as the bank account number) and the like is replaced with an algorithmically generated number. Of course, there is no need to generate a token, and the Real Time Payment request may be provided without generating a token. In other words, the Real Time Payment request or token may equally be used. These could be referred to as a Real Time Payment indicator.

This token is sent from the payment company 435 to the GDS system 415 using an API. This is step 3. By using a Real Time Payment indicator to pay for the trip, there is no requirement to contact the payment company as in the system of FIG. 3 and receive an authorisation from the payment company. This reduces the complexity of the system and also reduces the amount of data passing around the network.

The token is sent to the device 100 used by the travel agent 405. Of course, the travel agent 405 may retrieve the token from the GDS system 415. This is step 4.

The token is then sent to the financial institution 440 associated with the travel agent 405. For example, the financial institution 440 may be a bank associated with the travel agent or a corporate financial institution or may be prefunded account with the bank or other provider.

Once received by the financial institution 440, the financial institution acknowledges the receipt of the token to the travel agent. This is step 5.

The financial institution 440 then performs settlement of the funds with the merchant bank 450 defined in the token. In other words, the funds from the travel agents account are transferred to the merchant bank associated with the travel provider 430. This is step 6.

This settlement is notified to the travel agent 405 who then notifies the GDS system 415. This is step 7.

The GDS system 415 then notifies the travel provider 430 using a booking confirmation. This is step 8. Of course, the merchant bank 450 may notify the travel provider 430 in addition to or instead of the GDS system 415.

Obviously, numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

Embodiments of the disclosure may be generally defined as in the following paragraphs

1. A device in communication with a server over a network, the device comprising a processor and a network interface for communication over the network, wherein the processor is configured to: generate a request to purchase a trip and to send this request to the server using the network interface; the processor being further configured to receive a Real Time Payment indicator via the network interface and to send the received Real Time Payment indicator to a financial institution.

2. A device according to clause 1, wherein the Real Time Payment indicator is a Real Time Payment Request token.

3. A server in communication with a device over a network, the server comprising a processor and a network interface for communication over the network, wherein the processor is configured to: receive a request to purchase a trip via the network interface; receive a Real Time Payment indicator via the network interface from a payment company and to send the received Real Time Payment indicator to the device.

4. A server according to clause 3, wherein the Real Time Payment indicator is a Real Time Payment Request token.

5. A method comprising: generating a request to purchase a trip and to send this request to a server using a network interface; receiving a Real Time Payment indicator via the network interface; and sending the received Real Time Payment indicator to a financial institution.

6. A method comprising receiving a request to purchase a trip via a network interface; receiving a Real Time Payment indicator via the network interface from a payment company; and sending the received Real Time Payment indicator to a device.

7. A method according to either one of clause 5 or 6, wherein the Real Time Payment indicator is a Real Time Payment Request token.

8. A computer program containing computer readable instructions which loaded onto a computer configure the computer to perform a method according to any one of clause 5 to 7.

1. A device in communication with a server over a network, the device comprising a processor and a network interface for communication over the network, wherein the processor is configured to: generate a request to purchase a trip and to send this request to the server using the network interface; the processor being further configured to receive a Real Time Payment indicator via the network interface and to send the received Real Time Payment indicator to a financial institution.

2. A device according to claim 1, wherein the Real Time Payment indicator is a Real Time Payment Request token.

3. A server in communication with a device over a network, the server comprising a processor and a network interface for communication over the network, wherein the processor is configured to: receive a request to purchase a trip via the network interface; receive a Real Time Payment indicator via the network interface from a payment company and to send the received Real Time Payment indicator to the device.

4. A server according to claim 3, wherein the Real Time Payment indicator is a Real Time Payment Request token.

5. (canceled)

6. A method comprising receiving a request to purchase a trip via a network interface; receiving a Real Time Payment indicator via the network interface from a payment company; and sending the received Real Time Payment indicator to a device.

7. A method according to claim 6, wherein the Real Time Payment indicator is a Real Time Payment Request token.

8. (canceled)
